(19) United States
(12) Patent Application Publication
(10) Pub. No.: US 2002/0091917 A1
(43) Pub. Date: Jul. 11, 2002

(54) Method for control of multiple operating systems and electronic machines applicable thereto

(76) Inventor: Cheng-Chi Liao, Taipei (TW)

Correspondence Address: SUPREME PATENT SERVICES, P.O. BOX 3316, SARATOGA, CA, 95070, US

(21) Appl. No.: 09/754,978

(22) Filed: Jan. 5, 2001

(51) Int. Cl. G06F 9/00

(52) U.S. Cl. 713/1

(57) ABSTRACT

A method for control of multiple operating systems is applied to detect whether a Hard Disk Drive (HDD) is connected with a system bus of an electronic machine by using a Basic Input and Output System (BIOS). If the result is “true,” an operating system stored in the HDD will start the machine, otherwise, another operating system stored in a flash ROM (Read Only Memory) module will start the machine instead. The operating system in the flash ROM module serves a back-up system for booting the electronic machine in case of a HDD booting failure.

### BACKGROUND OF THE INVENTION

1. Field of the Invention

This invention relates to a method for control of multiple operating systems, particularly to a method using program codes of the Basic Input and Output System (BIOS) to detect whether a Hard Disk Drive (HDD) is coupled to the system bus of an electronic machine or not; if positive, an operating system (OS) in the HDD, otherwise an operating system (OS) in a flash ROM module, will go booting the electronic machine.

2. Description of the prior Art

In booting an electronic machine, such as an Information Appliance (IA), a Personal Digital Assistant (PDA), or a notebook computer, there are two main operating systems widely used and selectable basing on a user's favorite, including:

1. An IC base flash ROM (Read Only Memory) module having a Real-time operating system and requisite programs with relatively high reliability and durability compared with generic storage media. The Flash ROM module is preferably applied in a small size embedding operating system because of its limited storage capacity and high cost, and its operable space is considerably compressed owing to the requirements of the operation interface of massive icons and graphics.

2. A HDD base module for storage of an operating system of the Microsoft Window 98 or the like. The HDD today is a gigantic warehouse counted by gigabytes capable of storing massive data and application programs particularly for Microsoft's window operating environment when the user's operating interface is appealing for “fancy.” However, as the HDD structure is rather fragile, it is possible to incur an operation failure of the electronic machine should some hub portion of the HDD is impaired.,

### SUMMARY OF THE INVENTION

The primary object of this invention is to provide a method for control of multiple operating systems and electronic machines applicable thereto, wherein an IC base flash ROM (Read Only Memory) module and a HDD (Hard Disk Drive) base module are resided together for booting an electronic machine either by the flash ROM module or the HDD base module.

Another object of this invention is to provide a HDD with different operating systems or different functions for application of a multiple operating system in an electronic machine if a flash ROM module of the electronic machine cannot be updated effectively.

Yet another object of this invention is to provide a far-end debug and maintenance function via a flash ROM booting system.

In order to realize abovesaid objects, the electronic machine applicable to the method for control of multiple operating systems shall comprise at least: a Central Processing Unit (CPU); a memory unit having program codes of a Basic Input and Output System (BIOS); a flash ROM module; and a system bus connecting to the CPU, the memory unit, and the flash ROM module.

The procedure of abovesaid method comprises:

(a) Prompting the CPU to run the BIOS program codes for system booting to detect if the system bus of the electronic machine is connected with the HDD;

(b) Starting an operating system (OS) stored in the HDD If the result of the step (a) is found “true;” or,

(c) Starting an operating system stored in the flash ROM module if the step (a) is found “false.”

Moreover, an electronic machine for control of abovesaid method comprises at least: a CPU; a memory unit having BIOS program codes; a flash ROM module; and a system bus for connection with the CPU, the memory unit, and the flash ROM module. The electronic machine is characterized in: having a detection program code for booting included in the BIOS program codes to prompt the CPU to run and detect whether the system bus is connected with a HDD? If positive, the electronic machine shall choose and run the operating system stored in the HDD, otherwise, start that stored in the flash ROM module.

For more detailed information regarding this invention together with further advantages or features thereof, at least an example of preferred embodiment will be elucidated below with reference to the annexed drawings.

### BRIEF DESCRIPTION OF THE DRAWINGS

The related drawings in connection with the detailed description of this invention, which is to be made later, are described briefly as follows, in which:

FIG. 1 is a structure diagram of an electronic machine of this invention; and

FIG. 2 shows a flowchart of this invention's method.

### DETAILED DESCRIPTION OF THE PREFERRED EMBODIMENT

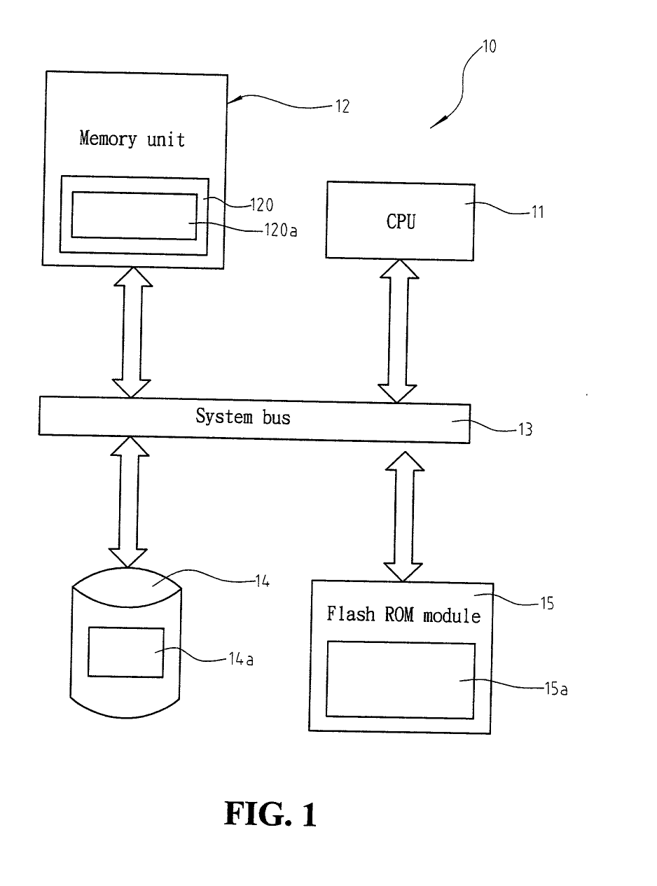

An electronic machine 10 shown in FIG. 1 comprises at least: a memory unit 12, a Central Processing Unit (CPU) 11, a flash ROM module 15, a Hard Disk Drive (HDD) 14, and a system bus 13.

The memory unit 12 contains a Basic Input and Output System's program codes 120 (abbrev. BIOS 120 hereinafter), which further includes a Power-On Self Test (POST) program code 120a to prompt the CPU 11 to detect whether the system bus 13 is connected with the HDD 14 or not? If true, an operating system (OS) 14a stored in the HDD 14 is started, otherwise, an operating system (OS) 15a stored in the flash ROM module 15 is started alternatively. The HDD 14 is optional depending on a user's requirements, and the system bus 13 is used to joint the memory unit 12, the CPU 11, the flash ROM module 15, and the HDD 14 together. The electronic machine 10 shown in FIG. 1 may be a Personal Digital Assistant (PDA), a notebook computer, a desktop computer, or an Information Appliance (IA), etc.

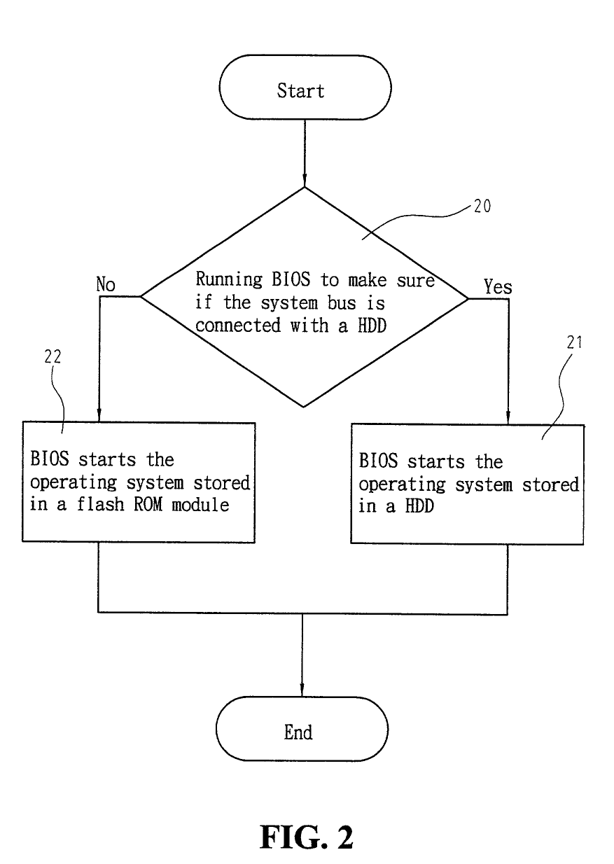

Referring to a flowchart shown in FIG. 2, after power supply is effected in the electronic machine 10, the electronic machine 10 will run the BIOS 120 (step 20) to make sure whether the HDD 14 is connected to the system bus 13 or not? If true, the program goes to step 21, otherwise, to step 22.

The step 20 of the electronic machine 10 is to prompt the CPU to run the POST program code 120a to make sure if the HDD 14 is connected to the system bus 13. The steps 21 and 22 would prompt the BIOS 120 to start the OS 14a stored in the HDD 14 or the OS 15a in the flash ROM module 15 respectively. Namely, after checking with the POST program code 120a, the BIOS 120 will run either the OS 14a of the HDD 14 or the OS 15a of the flash ROM module 15 depending on the connection or disconnection relationship between the HDD 14 and the system bus 13.

Besides, the OS 14a and the OS 15a shown in FIG. 1 may be arranged to meet different design requirements of the electronic machine 10, for example, on the viewpoint of back-up booting system, the OS 14a may be a complicated operating system while the OS 15a is a reduced operating system just well enough to boot the electronic machine 10 and for basic operation. When standing at a viewpoint of multiple operating systems, the IDS 14a may be considered a operating system and the OS 15a is another different operating system. Or, standing at a viewpoint of far-end debug and maintenance, the OS 15a is considered an operating system for far-end debug and maintenance of the electronic machine 10.

In the above described, at least one preferred embodiment has been elucidated with reference to the drawings annexed, and it is apparent that numerous variations or modifications may be made without departing from the true spirit and scope thereof, as set forth in the claims below.

What is claimed is:

1. A method for control of multiple operating systems applicable to an electronic machine, wherein the electronic machine comprises at least: a Central Processing Unit (CPU); a memory unit having program codes of a Basic Input and Output System (BIOS); a flash ROM module; and a system bus connecting to the CPU, the memory unit, and the flash ROM module; the method comprising the following steps:
(a) Prompting the CPU to run the BIOS program codes for system booting to make sure if the system bus of the electronic machine is connected with a HDD;
(b) Starting an operating system (OS) stored in the HDD if the result of the step (a) is found “true;” or,
(c) Starting an operating system (OS) stored in the flash ROM module if the result of the step (a) is found “false.”

2. An electronic machine provided with multiple operating systems, comprising at least: a Central Processing Unit (CPU); a memory unit having program codes of a Basic Input and Output System (BIOS); a flash ROM module; and a system bus connecting together with the CPU, the memory unit, and the flash ROM module; and the electronic machine being characterized in:
the program codes of the BIOS containing a POST (Power-On Self Test) program code for the CPU to fetch and nun for checking whether the system bus is connected to a Hard Disk Drive (HDD); an operating system stored in the HDD being started if the result is found “true”, otherwise, another operating system stored in the flash ROM module will be started instead.

3. The electronic machine according to claim 2, wherein the electronic machine is a Personal Digital Assistant (PDA).

4. The electronic machine according to claim 2, wherein the electronic machine is a notebook computer.

5. The electronic machine according to claim 2, wherein the electronic machine is a desktop computer.

6. The electronic machine according to claim 2, wherein the electronic machine is an Information Appliance (IA).
